(19) United States
(12) Patent Application Publication
(10) Pub. No.: US 2026/0195910 A1
(43) Pub. Date: Jul. 9, 2026

(54) OBJECT SIZE AND DISTANCE DETERMINATION USING IMAGE PROCESSING

(71) Applicant: GM Global Technology Operations LLC, Detroit, MI (US)

(72) Inventors: Tzvi Philipp, Bet Shemesh (IL); Igal Kotzer, Tel Aviv (IL)

(21) Appl. No.: 19/014,422

(22) Filed: Jan. 9, 2025

(51) Int. Cl. G06T 7/536; G06T 7/571; G06T 7/579; G06T 7/60

(52) U.S. Cl. CPC G06T 7/536; G06T 7/571; G06T 7/579; G06T 7/60; G06T 2207/10016; G06T 2207/30252

(57) ABSTRACT

A vehicle includes a camera in communication with a controller. An inertial motion unit (IMU) is in communication with the controller. The controller includes a processor and a non-transitory memory configured to store a set of sequential images generated by the camera and configured to associate vehicle velocity and acceleration data from the IMU with each image in the set of sequential images. An object size and distance determination module is stored in one or both of the controller and an external computer system. The object size and distance determination module is configured to determine a distance of an object in the set of sequential images from the vehicle using the images and the associated vehicle velocity and acceleration data.

The subject disclosure relates to image processing, and in particular to a system for identifying a size and distance of an object captured in sequential images.

Vehicles frequently includes vision systems, and other camera systems that provide images to a controller. The controller in turn utilizes those images to operate one or more vehicle functions including autonomous vehicle operations (e.g. self driving) and semi-autonomous vehicle operations (e.g. assisted parking). In some cases, all or a portion of the captured images can be stored and utilized alongside appropriately stored meta data provided by other systems.

Absent the addition of other sensor data, however, the distances between objects captured in the images and the vehicle capturing the images, is not a known quantity and is therefore not typically included in the image meta data.

It is desirable to provide a process for identifying distances between objects and a vehicle using images captured by the vehicle.

### SUMMARY

In one exemplary embodiment a vehicle includes a camera in communication with a controller. An inertial motion unit (IMU) is in communication with the controller. The controller includes a processor and a non-transitory memory configured to store a set of sequential images generated by the camera and configured to associate vehicle velocity and acceleration data from the IMU with each image in the set of sequential images. An object size and distance determination module is stored in one or both of the controller and an external computer system. The object size and distance determination module is configured to determine a distance of an object in the set of sequential images from the vehicle using the images and the associated vehicle velocity and acceleration data.

In addition to one or more of the features described herein the object size and determination module is stored in the external computer system, and wherein the controller is in communication with the external computer system.

In addition to one or more of the features described herein, the object is an object of known size and determining the distance of the object in the set of sequential images from the vehicle includes measuring an object dimension of the object in pixels, determining an image size of the object by multiplying the object dimension by a pixel size, determining a magnification of the camera as a ratio of the object dimension size and a corresponding actual object dimension, determining the distance of the vehicle from the object at a time the image was captured according to mag=f/(z−f) where mag is the magnification of the camera, z is the distance of the vehicle from the object and f is a focal length of the camera.

In addition to one or more of the features described herein the object dimension of the object is a length of a line across the object where the line is aligned with an axis of a plane defining the image.

In addition to one or more of the features described herein the object dimension is an area of a bounding box surrounding the object.

In addition to one or more of the features described herein includes a second object in the set of images, the second object being an unknown size, and the object size and distance determination module is configured to determine a size of the second object and a distance from the vehicle of the second object using the set of sequential images and the associated vehicle velocity and acceleration data.

In addition to one or more of the features described herein the size of the second object and the distance of the second object is determined by identifying a travel distance of the vehicle between sequential images containing the second object using the vehicle velocity and acceleration data, identifying an image size of the second object in each image in the set of sequential images based on a measured object dimension of the second object in each image, calculating a distance traveled between sequential images using the vehicle velocity and acceleration data and time stamp data of the images in the set of sequential images, calculating an image magnification of the second object using a size change of the first object, calculating a distance of the vehicle to the second object by multiplying the magnification and the focal length of the camera.

In addition to one or more of the features described herein vehicle velocity and acceleration data is a scalar vehicle velocity and a scalar acceleration.

In addition to one or more of the features described herein the vehicle velocity and acceleration data is a vector including three dimensions.

In another exemplary embodiment A method for analyzing objects in an image includes storing a set of sequential images generated by a vehicle camera, associating vehicle velocity and acceleration data from the IMU with each image in the set of sequential images using a vehicle controller, determine a distance of an object in the set of sequential images from the vehicle using the images and the associated vehicle velocity and acceleration data using an object size and distance determination module stored in one or both of a controller and an external computer system.

In addition to one or more of the features described herein the object size and determination module is stored in the external computer system, and wherein the vehicle controller is in communication with the external computer system.

In addition to one or more of the features described herein the object is an object of known size and determining the distance of the object in the set of sequential images from the vehicle includes measuring an object dimension of the object in pixel, determining an image size of the object by multiplying the object dimension by a pixel size, determining a magnification of the camera as a ratio of the object dimension size and a corresponding actual object dimension, determining the distance of the vehicle from the object at a time the image was captured according to mag=f/(z-f) where mag is the magnification of the camera, z is the distance of the vehicle from the object and f is a focal length of the camera.

In addition to one or more of the features described herein the object dimension of the object is a length of a line across the object where the line is aligned with an axis of a plane defining the image.

In addition to one or more of the features described herein the object dimension is an area of a bounding box surrounding the object.

In addition to one or more of the features described herein, the method further includes a second object in the set of images, the second object being an unknown size, and the object size and distance determination module is configured to determine a size of the second object and a distance from the vehicle of the second object using a the set of sequential images and the associated vehicle velocity and acceleration data.

In addition to one or more of the features described herein the size of the second object and the distance of the second object is determined by identifying a travel distance of the vehicle between sequential images containing the second object using the vehicle velocity and acceleration data, identifying an image size of the second object in each image in the set of sequential images based on a measured object dimension of the second object in each image, calculating a distance traveled between sequential images using the vehicle velocity and acceleration data and time stamp data of the images in the set of sequential images, calculating an image magnification of the second object using a size change of the first object, and calculating a distance of the vehicle to the second object by multiplying the magnification and the focal length of the camera.

In addition to one or more of the features described herein vehicle velocity and acceleration data is a scalar vehicle velocity and a scalar acceleration.

In addition to one or more of the features described herein the vehicle velocity and acceleration data is a vector including three dimensions.

In yet another exemplary embodiment a method for analyzing objects in an image includes storing a set of sequential images generated by a vehicle camera. The method associates vehicle velocity and acceleration data from the IMU with each image in the set of sequential images using a vehicle controller and determines a distance of an object in the set of sequential images from the vehicle using the images and the associated vehicle velocity and acceleration data using an object size and distance determination module stored in one or both of a controller and an external computer system. The object is an object of known size and determining the distance of the object in the set of sequential images from the vehicle includes measuring an object dimension of the object in pixels, determining an image size of the object by multiplying the object dimension by a pixel size, determining a magnification of the camera as a ratio of the object dimension size and a corresponding actual object dimension, determining the distance of the vehicle from the object at a time the image was captured according to mag=f/(z−f) where mag is the magnification of the camera, z is the distance of the vehicle from the object and f is a focal length of the camera, further comprising a second object in the set of images, the second object is an unknown size, and the object size and distance determination module is configured to determine a size of the second object and a distance from the vehicle of the second object using a the set of sequential images and the associated vehicle velocity and acceleration data. A size of the second object and the distance of the second object is determined by identifying a travel distance of the vehicle between sequential images containing the second object using the vehicle velocity and acceleration data, identifying an image size of the second object in each image in the set of sequential images based on a measured object dimension of the second object in each image, calculating a distance traveled between sequential images using the vehicle velocity and acceleration data and time stamp data of the images in the set of sequential images, calculating an image magnification of the second object using a size change of the first object, calculating a distance of the vehicle to the second object by multiplying the magnification and the focal length of the camera.

In addition to one or more of the features described herein the vehicle velocity and acceleration data is a vector including three dimensions.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic representation of a vehicle;

FIG. 2 is a diagrammatic representation of how an image of an object is formed in a camera;

FIG. 3 is a process for determining a distance of an object of known size from the vehicle;

FIG. 4 is a process for determining a size of an object of unknown size and a distance of the object from the vehicle; and

FIG. 5 is a schematic representation of certain features of the process of FIG. 4.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to a system including at least a processor and a memory, with the system being configured to perform or cause to be performed at least one operation. The system can be a dedicated controller including a single purpose processor and memory, a general control system including one or more modules for performing the operation, a distributed system including multiple controllers in communication with each other and configured to control the operation, or any similar system configured to control the operation.

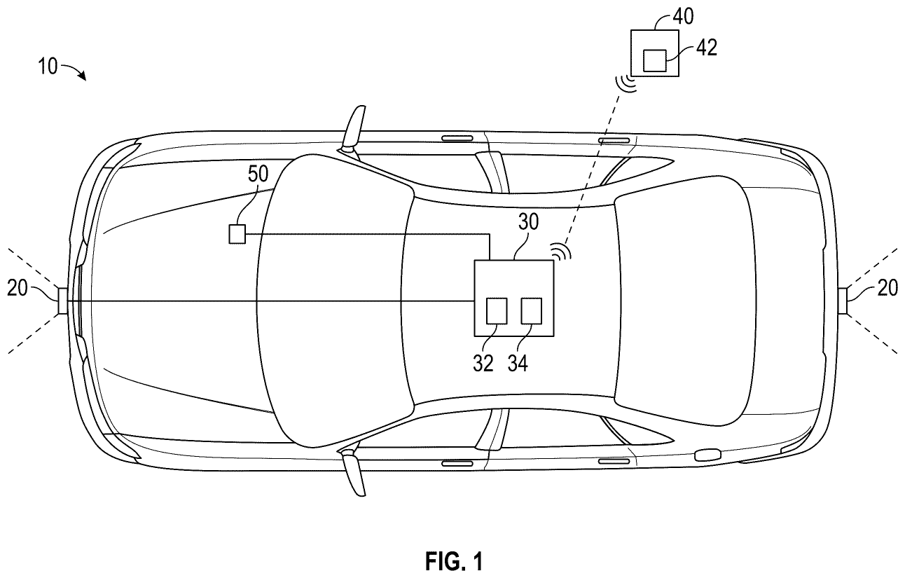

In accordance with an exemplary embodiment, FIG. 1 illustrates a vehicle 10 including multiple exterior facing cameras 20. Each of the cameras 20 is in communication with a controller 30. The controller 30 includes a memory 32 and a processor 34. The memory 32 is configured to store a set of images, and corresponding meta data derived from sensors within the vehicle 10. The controller 30 is able to communicate with one or more external computing systems 40. In some examples, the communication can be via a wireless communication (as illustrated). In other examples, the communication may be via a physical connection established after the vehicle 10 is parked. In the example of FIG. 1, the external computing system includes an object size and determination module (module 42) configured to perform the determination described here. In alternate examples, the module 42 may be included in the controller 30, or portions of the operation may be distributed between controller 30 and the external computing system 40.

One of the controller 30 and the remote computing system 40 includes a control module able to derive the size of, and distance to, static objects captured by the cameras 20 using sequential frames from a single camera 20 while the vehicle 10 is in motion. The distance derived is a distance between the object and the imaging sensor (camera 20) that captures the object. As used herein, this distance is referred to generally as the distance between the object and the vehicle 10. In practical applications, such as map creation or updating, the distance is beneficially drawn to a single point on the vehicle 10 (e.g. a camera 20 location) throughout a duration of the operation. This process uses movement information from conventional vehicle sensors, such as an inertial measurement unit (IMU 50) to determine the velocity and acceleration of the vehicle in a dimensional space (e.g., X, Y, and Z directions). In addition, a time stamp of each frame is recorded.

In one example, the data collector is a sensor having a known pixel size and focal length. The controller 30 uses the object size in the captured images, and distances determined using the IMU 50 to determine distances from the vehicle 10 to the objects at any given time in the recording.

In one example, the determined distances are used by the external computing system 40 to create a three dimensional volumetric map of an urban region (or any other region through which the vehicle 10 traveled) using images from a single camera 20 mounted on a data collection vehicle (vehicle 10). In another example, the process is used to simplify data annotation in three dimensions.

In yet further examples, where the camera 20 technology provides sufficient edge definition between objects and where the vehicle processing power is sufficient, the distances may be used on-board the controller 30 and provided to vehicle systems and/or other controller modules in real time or near real time.

The processes operated by the controller 30 utilize the fact that the camera 20 has a known focal length and a known pixel size/count in conjunction with the magnification of the lens within the camera 20 to determine the distance from the camera 20 (and thus, from the vehicle 10) to the object.

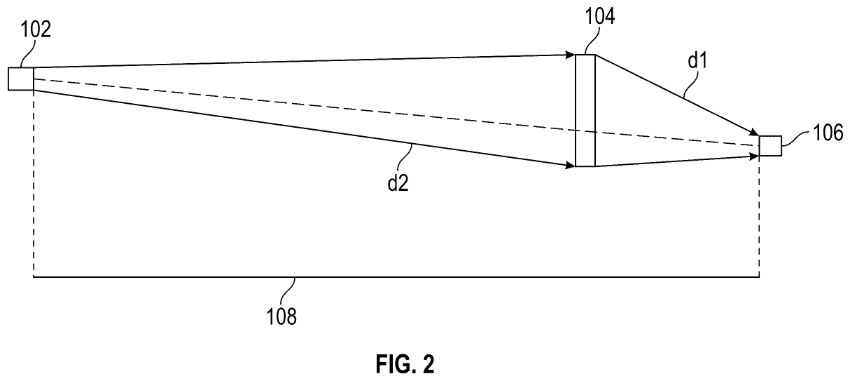

With continued reference to FIG. 1, FIG. 2 illustrates a camera magnification according to one example. The magnification provided by a lens 104 for a camera 20 is defined as mag=(d_1)/d_2 where d2 is a line connecting the object 102 to the lens 104 and d1 is a line from the lens 104 to a sensing element 106 of the camera 20 used to generate the image; where the line passes through a center of an aperture stop of the camera 20. The ratio between d1 (referred to as the image distance) and d2 (referred to as the object distance) defines the magnification (mag) that the resultant image has due to the lens 104.

The magnification can also be defined as the ratio between the image size and the object size according to mag=(image_size)/(object_size). In most automotive applications the distance d1 between the lens 104 and the image sensor 106 is a fixed distance. This configuration is referred to as a fixed focus lens. In the example of FIG. 2, d2 is the distance used to calibrate the distance d1 by adjusting the lens 104 position such that the image generated is as sharp as possible during a production calibration. The d1 distance is then fixed.

For any given lens 104, the magnification changes based on the object distance d2 according to deterministic profiles. The particular deterministic profile of any given camera 20 configuration is determinable during design and calibration and is within the skill in the art. As a result of the magnification changes, in sequential images, the camera 20 is moved relative to the same object 102 (e.g., by the vehicle 10 driving, the resultant images at sensor 106 will be of different sizes.

When the object 102 captured in the image is of a known size (e.g., when the object is the type of object having a standardized size), then for that object 102 at any distance d2 the conversion of pixels to unit length can be determined. In addition when each object is sized to within the resolution of the pixel, or when the imaging system is capable of distinguishing a difference in size to the scale of one pixel, objects within a range of z distances will have a unique functional form of the change in the number of pixels per the object distance d2.

In such cases, the expression for the magnification can be rewritten in terms of the focal length f and d2 only based on a thin lens approximation in the form of:

$$\frac{1}{f} = \frac{1}{{d}_{2}} + \frac{1}{{d}_{1}}$$

The thin lens approximation allows the magnification to be written as:

$$m a g = \frac{f}{{d}_{2} - f}$$

which can be further generalized for any distance z as:

$$m a g = \frac{f}{z - f} .$$

The change in magnification as a function of the object distance is:

$$\frac{d ( m a g )}{d z} = - \frac{f}{{( z - f )}^{2}} = \frac{{}^{′} - mag}{( z - f )} .$$

In the systems and process described herein, the image is generated via a digital (camera) made up of a Cartesian array of pixels of uniform dimension in the x and y direction. In alternate implementations, the processes described herein could be used where the image is captured on film (and thus lacks any pixels), or where there is no fixed pixel size (e.g., the camera 20 was comprised of pixels that are not uniform in dimension) by separately calibrating in the x and y axis and/or applying a fixed grid to the image after the image is formed and then resampled.

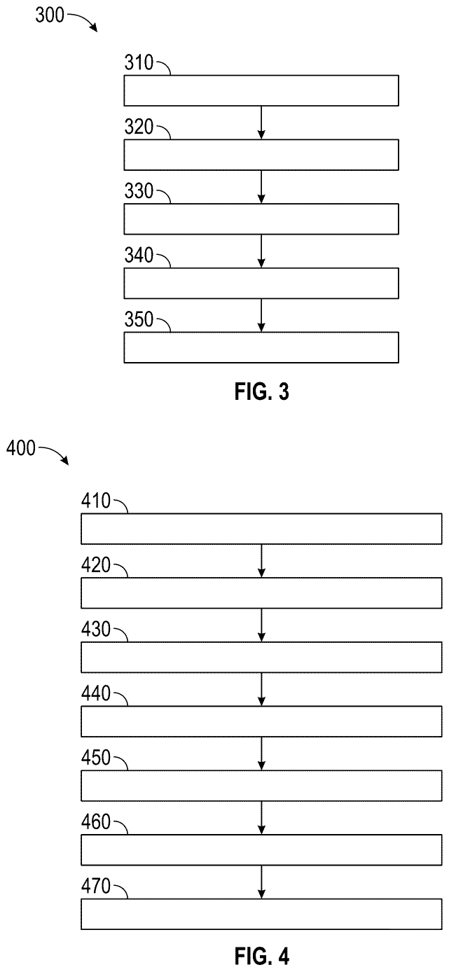

One example process 300 performed by the controller 30 or the external computing system 40 is illustrated in FIG. 3 and determines the distance from the vehicle 10 to an object captured in an image where the object has a known size (e.g. an object having a standardized size, such as a traffic sign).

Initially the camera 20 captures an image of an object at a point in time (T1) in a capture object at T1 step 310. Using the captured image, an object dimension along the x or y axis of the image is measured in pixels at a measure object dimension step 320. The measurement can be taken as a direct manual measurement of the object via an image processing tool or by visually observing the extent of the object by counting the number of pixels along the given dimension. In alternate examples, dimensions of a bounding box drawn around the object may be used as a proxy for the dimension of the object itself, provided the bounding box is within a threshold percent of the object size. In one example, the threshold percent is such that the bounding box is less than or equal to 5% greater than the actual dimension. The number of pixels of the object dimension is signified as Nₖ. The particular threshold percentage is a parameter that is may be selected and/or altered depending on the specific application including the technical specifications of the camera 20 as well as the surrounding environment.

As the size of each pixel is a known quantity, p, the image size of the object is determined by multiplying Nₖ·p in a determine image size of object step 330. The magnification of the object provided by the lens 104 is dependent on the distance d2, and is a ratio of the determined image size of the object 102 to the actual physical size of the object 102. The magnification is determined in a determine magnification step 340.

As the magnification follows a formula

$$m a g = \frac{f}{z - f}$$

where z is the distance between the object and the vehicle and f is the focal length, the distance between the object and the vehicle is algebraically determined at a determine distances step 350.

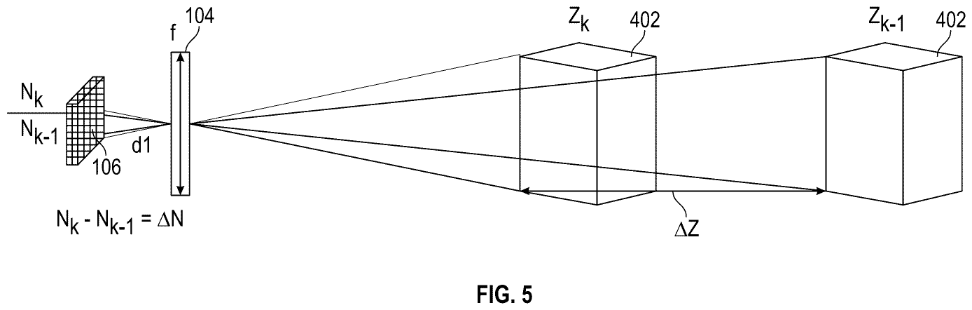

With continued reference to FIGS. 1-3, FIG. 4 illustrates a process 400 for determining a distance to an object 402 (illustrated in FIG. 5) of unknown size, where at least a portion of the images in sequence also include an object of a known size and FIG. 5 provides a schematic representation of certain features of the process 400.

The process 400 receives sequential images of the object 402 in a capture sequential images T1 . . . . Tn step 410. Each of the images has associated meta data defining the velocity of the vehicle 10 and the acceleration of the vehicle 10 at the time the image was captured. In some examples, the meta data is determined by the IMU 50 contemporaneously with the capturing of the images. The meta data may include additional information, such as satellite navigation system coordinates, when such additional information is available.

For each subsequent image from the camera 20 in which the vehicle is moving forward (or backward), the distance traveled by the vehicle 10 is determined according to the expression

$$z = ( v \cdot t + \frac{1}{2} a {t}^{2} )$$

at a determine travel distance between images step 420, where v is the velocity of the vehicle 10 and a is the acceleration as measured by the IMU 50 during the duration of time t (time difference) between images. Treating the travel distance as a scalar value, as is done here, provides for a simplification of the process and a reduction in processing power required. This process uses an average velocity and acceleration during the time duration t. The velocity and acceleration terms used are scaler values (not vectors) during the time duration t. All motion is considered along the z axis, which is defined as the direction of movement of the vehicle 10.

For each image captured in the sequence of images, the image size in pixels is determined in the same manner as the process 300 of FIG. 3, in a determine image size step 430. At each subsequent image, the image size in pixels of the objects are measured and the difference in number of pixels for the pixel sizes (referred to as the delta pixels) per change in position of the vehicle (referred to as delta z) is determined and stored as AN/Az in a determine delta pixels and delta z step 440.

For each image subsequent to the initial image (Tn, Tn+1, etc.) the ratio of the size of the object in pixels to Az/AN identifies the distance in z of the object from the first image. This relationship can be represented as

$$z = \frac{Δ z}{Δ {N}_{k}} {N}_{k - 1} \cdot p .$$

A captured image of the unknown sized object in the same image as an object of a known size results in an image of Nᵤₖⁱ⁻¹·p pixels, where the i is the ith image (i−1) and the “u” signifies the unknown object in Nₖ pixels. Since the object of unknown size and the object of known size appear in the same images, the distances traveled between images (Δz) is the same. The process 400 uses this relationship to identify the distance traveled between images in a determine distance traveled step 450.

To determine the size of the object 402 where the size is unknown, ΔNᵤₖ is determined and the ratio of

$$\frac{Δ z}{Δ {N}_{u k}}$$

is calculated. Since the Nᵤₖⁱ⁻¹·p is measured and the z value is calculated the magnification is determined in the same manner as the process 300 in a determine magnification step 460. The size of the object is then algebraically determined from the known values.

Due to measurement error in the number of pixels on the object at either large distances (due to defocusing) or small objects (due to resolution) at any distance, the resultant z value error may be much larger than the error over the object size, and the implementation of the process may be limited to objects within a certain distance of the vehicle and/or objects above a certain size.

To accommodate the possible measurement error, the average size of the object 402 is calculated over a few subsequent images (e.g., 4 to 5 images) and an average object size is used to calculate the z distance according to:

$$z = \frac{f \cdot \overline{object\_size}}{image\_size ( z )}$$

in a calculate distance (z) step 470. The z distance is the distance from the object 102 to the vehicle 10 at a given point in time.

In one extension of this process, the singular scalar value representing the distance between the object 102 and the vehicle 10 may be decomposed into motion vectors of velocity and acceleration, with each vector having three x, y, z components. The decomposition allows the process to account for directional shifts of the vehicle 10 along its path. Object rotations and perspective corrections along the x, y, z direction can be applied to the images to fine tune the sizes in order to account for how the object is positioned relative to the environment and/or how the vehicle motion relative to the object creates changes in perspective.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a camera in communication with a controller;
an inertial motion unit (IMU) in communication with the controller;
the controller comprising a processor and a non-transitory memory, the memory being configured to store a set of sequential images generated by the camera and configured to associate vehicle velocity and acceleration data from the IMU with each image in the set of sequential images;
an object size and distance determination module stored in one or both of the controller and an external computer system; and
wherein the object size and distance determination module is configured to determine a distance of an object in the set of sequential images from the vehicle using the images and the associated vehicle velocity and acceleration data.

2. The vehicle of claim 1, wherein the object size and determination module is stored in the external computer system, and wherein the controller is in communication with the external computer system.

3. The vehicle of claim 1, wherein the object is an object of known size and determining the distance of the object in the set of sequential images from the vehicle comprises:
measuring an object dimension of the object in pixels;
determining an image size of the object by multiplying the object dimension by a pixel size;
determining a magnification of the camera as a ratio of the object dimension and a corresponding actual object dimension; and
determining the distance of the vehicle from the object at a time the image was captured according to
$$m a g = \frac{f}{z - f}$$
where mag is the magnification of the camera, z is the distance of the vehicle from the object and f is a focal length of the camera.

4. The vehicle of claim 3, wherein the object dimension of the object is a length of a line across the object where the line is aligned with an axis of a plane defining the image.

5. The vehicle of claim 3, wherein the object dimension is an area of a bounding box surrounding the object.

6. The vehicle of claim 3, further comprising a second object in the set of images, the second object being an unknown size, and the object size and distance determination module is configured to determine a size of the second object and a distance from the vehicle of the second object using the set of sequential images and the associated vehicle velocity and acceleration data.

7. The vehicle of claim 6, wherein the size of the second object and the distance of the second object is determined by:
identifying a travel distance of the vehicle between sequential images containing the second object using the vehicle velocity and acceleration data;
identifying an image size of the second object in each image in the set of sequential images based on a measured object dimension of the second object in each image;
calculating a distance traveled between sequential images using the vehicle velocity and acceleration data and time stamp data of the images in the set of sequential images;
calculating an image magnification of the second object using a size change of the first object; and
calculating a distance of the vehicle to the second object by multiplying the magnification and the focal length of the camera.

8. The vehicle of claim 1, wherein vehicle velocity and acceleration data is a scalar vehicle velocity and a scalar acceleration.

9. The vehicle of claim 1, wherein the vehicle velocity and acceleration data is a vector including three dimensions.

10. A method for analyzing objects in an image comprising:
storing a set of sequential images generated by a vehicle camera;
associating vehicle velocity and acceleration data from the IMU with each image in the set of sequential images using a vehicle controller; and
determining a distance of an object in the set of sequential images from the vehicle using the images and the associated vehicle velocity and acceleration data using an object size and distance determination module stored in one or both of a controller and an external computer system.

11. The method of claim 10, wherein the object size and determination module is stored in the external computer system, and wherein the vehicle controller is in communication with the external computer system.

12. The method of claim 10, wherein the object is an object of known size and determining the distance of the object in the set of sequential images from the vehicle comprises:
measuring an object dimension of the object in pixels;
determining an image size of the object by multiplying the object dimension by a pixel size;
determining a magnification of the camera as a ratio of the object dimension size and a corresponding actual object dimension; and
determining the distance of the vehicle from the object at a time the image was captured according to
$$m a g = \frac{f}{z - f}$$
where mag is the magnification of the camera, z is the distance of the vehicle from the object and f is a focal length of the camera.

13. The method of claim 12, wherein the object dimension of the object is a length of a line across the object where the line is aligned with an axis of a plane defining the image.

14. The method of claim 12, wherein the object dimension is an area of a bounding box surrounding the object.

15. The method of claim 12, further comprising a second object in the set of images, the second object being an unknown size, and the object size and distance determination module is configured to determine a size of the second object and a distance from the vehicle of the second object using a the set of sequential images and the associated vehicle velocity and acceleration data.

16. The method of claim 15, wherein the size of the second object and the distance of the second object is determined by:
identifying a travel distance of the vehicle between sequential images containing the second object using the vehicle velocity and acceleration data;
identifying an image size of the second object in each image in the set of sequential images based on a measured object dimension of the second object in each image;
calculating a distance traveled between sequential images using the vehicle velocity and acceleration data and time stamp data of the images in the set of sequential images;
calculating an image magnification of the second object using a size change of the first object; and
calculating a distance of the vehicle to the second object by multiplying the magnification and the focal length of the camera.

17. The method of claim 10, wherein vehicle velocity and acceleration data is a scalar vehicle velocity and a scalar acceleration.

18. The method of claim 10, wherein the vehicle velocity and acceleration data is a vector including three dimensions.

19. A method for analyzing objects in an image comprising:
storing a set of sequential images generated by a vehicle camera;
associating vehicle velocity and acceleration data from the IMU with each image in the set of sequential images using a vehicle controller;
determining a distance of an object in the set of sequential images from the vehicle using the images and the associated vehicle velocity and acceleration data using an object size and distance determination module stored in one or both of a controller and an external computer system,
wherein the object is an object of known size and determining the distance of the object in the set of sequential images from the vehicle comprises:
measuring an object dimension of the object in pixels;
determining an image size of the object by multiplying the object dimension by a pixel size;
determining a magnification of the camera as a ratio of the object dimension size and a corresponding actual object dimension;
determining the distance of the vehicle from the object at a time the image was captured according to
$$m a g = \frac{f}{z - f}$$
where mag is the magnification of the camera, z is the distance of the vehicle from the object and f is a focal length of the camera;
a second object in the set of images, the second object being an unknown size, and the object size and distance determination module is configured to determine a size of the second object and a distance from the vehicle of the second object using a the set of sequential images and the associated vehicle velocity and acceleration data, wherein a size of the second object and the distance of the second object is determined by:
identifying a travel distance of the vehicle between sequential images containing the second object using the vehicle velocity and acceleration data;
identifying an image size of the second object in each image in the set of sequential images based on a measured object dimension of the second object in each image;
calculating a distance traveled between sequential images using the vehicle velocity and acceleration data and time stamp data of the images in the set of sequential images;
calculating an image magnification of the second object using a size change of the first object; and
calculating a distance of the vehicle to the second object by multiplying the magnification and the focal length of the camera.

20. The method of claim 19, wherein the vehicle velocity and acceleration data is a vector including three dimensions.
